(19) United States
(12) Patent Application Publication
(10) Pub. No.: US 2026/0296067 A1
(43) Pub. Date: Oct. 1, 2026

(54) METHOD FOR CALIBRATION OF A PRINTER FOR TRANSPARENT MEDIA

(71) Applicant: CANON KABUSHIKI KAISHA, Tokyo (JP)

(72) Inventor: Marcus H.G.W. HEES, Echt (NL)

(21) Appl. No.: 19/578,683

(22) Filed: Mar. 25, 2026

(30) Foreign Application Priority Data
Mar. 27, 2025 (EP) 25166521.2

(51) Int. Cl. B41J 11/00; B41J 3/407; B41J 3/413

(52) U.S. Cl. CPC B41J 11/0095; B41J 3/4075; B41J 3/413; B41J 11/0085; B41J 11/001; B41J 2203/01

(57) ABSTRACT

A method for calibration of a printer for a transparent medium. The printer comprises a feed table for feeding media to a print surface comprising a vacuum system to suck media to the print surface, an area camera above the feed table for detecting fed media, and a print controller for controlling printing on print media. The method comprises the step of placing a sheet with an indicator line on top of the feed table at the position of a trailing edge of the transparent medium.

### CROSS-REFERENCE TO RELATED APPLICATIONS

This application claims priority to European Patent Application No. 25166521.2 filed on Mar. 27, 2025, which is incorporated by reference herein in its entirety.

### BACKGROUND OF THE DISCLOSURE

### Field of the Disclosure

The present disclosure relates to a method for calibration of a printer for a transparent medium. The printer has a user interface for interaction with a user of the printer, a feed table for feeding media to a print surface comprising a vacuum system to suck media to the print surface, an area camera above the feed table for detecting fed media, and a print controller for controlling printing on print media.

### Description of Background Art

A plurality of media can be loaded in an automated way in current printers. An area camera at the end of the feed table detects the leading edge of the print medium that is fed into the printer. The detection of the leading edge triggers a start of the printing on the print medium.

However, when the print medium is transparent the area camera cannot detect the leading edge of the print medium.

### SUMMARY OF THE DISCLOSURE

The disclosure is directed to a method to calibrate a printer for a transparent medium before printing on the transparent medium.

In accordance with the present disclosure, a method and a printer are provided.

According to the present disclosure, a width of the transparent medium and a position on the feed table of the transparent medium is stored in memory of a print controller. An adhesive element with an indication line like a tape or a flat magnetic sticker is manually stuck to a leading edge of the transparent medium by an operator of the printer. The operator places the leading edge of the transparent medium in a detection zone of the area camera that can detect a position of the adhesive element. The position of the adhesive element is stored in memory of the print controller as a leading edge position of the transparent medium. The vacuum system is turned on such that the transparent medium cannot move. The operator then places a sheet with an indicator line, like a sticker or a flat magnet, on top of the feed table at the position of a trailing edge of the transparent medium. The indicator line on the sheet is aligned with the trailing edge of the print medium. The operator enters a ready status of the printer in the user interface screen of the printer.

According to an embodiment, the method comprises the steps of, for each transparent medium to be printed, receiving a signal that the trailing edge of the transparent medium is aligned at the indicator line via a user interface of the printer, and starting printing on the transparent medium.

An advantage of the present disclosure is that no manual action is required after calibration for the operator like sticking tape to the media and removing the tape afterwards.

According to an embodiment, the user interface is a foot pedal of the printer

According to an embodiment, the sheet is a magnetic sheet or a sticker sheet.

According to an embodiment, the method comprises the step of recalibrating the printer according to the steps of the method before printing on a print medium, if the print medium of another size is fed into the printer.

The present disclosure further relates to a printer for printing transparent media. The printer comprises a feed table for feeding media to a print surface comprising a vacuum system to suck media to the print surface, an area camera above the feed table for detecting fed media, a user interface for indicating that media is fed on the feed table, a print controller which is configured to execute the steps of the method according to the present disclosure.

According to an embodiment, the printer is a sheet printer or a hybrid printer for printing on rolls and sheets.

The present disclosure also relates to a non-transitory computer-readable storage medium storing a computer program with instructions which, when the program is executed by a print controller of a printer, cause the computer to carry out the steps of the method according to the present disclosure.

Further scope of applicability of the present disclosure will become apparent from the detailed description given hereinafter. However, it should be understood that the detailed description and specific examples, while indicating embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic perspective view of a printing system according to the present disclosure;

FIG. 2 is a schematic top view of the printing system with respect to the first method of calibrating the printer according to the present disclosure;

FIG. 3 is a flow diagram of the first method of calibrating the printer according to the present disclosure;

FIG. 4 is a schematic top view of the printing system with respect to the second method of printing with the printer after calibration according to the present disclosure;

FIG. 5 is a flow diagram of the second method of printing with the printer after calibration according to the present disclosure; and

FIG. 6 shows schematically a computer-readable storage medium for storage of the application programs to execute the steps of the method according to the present disclosure.

### DETAILED DESCRIPTION OF THE EMBODIMENTS

The present disclosure will now be described with reference to the accompanying drawings, wherein the same reference numerals have been used to identify the same or similar elements throughout the several views.

### Printing System

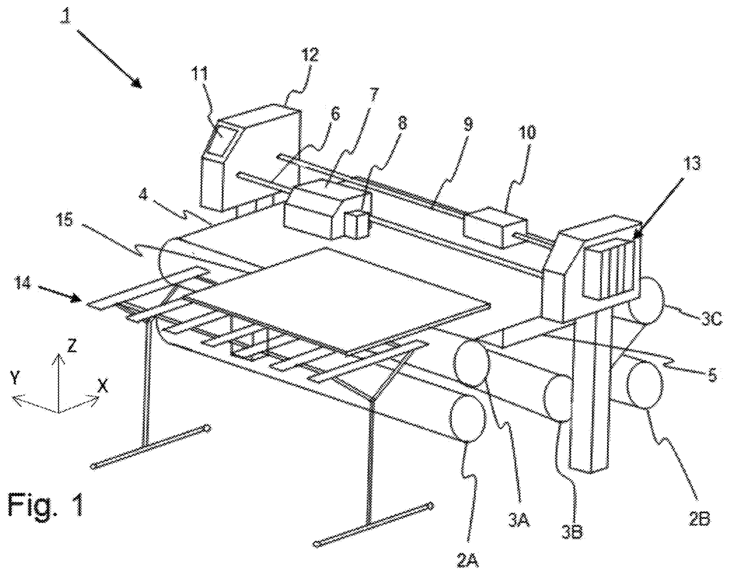

FIG. 1 shows a wide format inkjet printer 1. The wide-format printer 1 comprises an inkjet printing assembly 7 for printing on a print medium 15. The print medium 15 in FIG. 1 is a relatively rigid substrate, such as a panel. The print medium 15 is supplied from a media input unit 14, which may be configured for storing a plurality of such print media 15 and supplying these to the printer 1. The printer 1 comprises transport means for receiving and transporting the print medium 15 along the inkjet printing assembly 7. In FIG. 1, the transport means comprises an endless transport belt 4 supported on a plurality of support rollers 3A, 3B, 3C. At least one of the support rollers 3A, 3B, 3C is provided with driving means for moving the belt 4. Additionally, one or more of the support rollers 3A, 3B, 3C may be configured to be moved and/or tilted to adjust and control the lateral position of the belt 4. The inkjet printing assembly 7 may be provided with a sensor 8, such as a CCD camera, to determine the relative position of belt 4 and/or the print medium 15. Data from said sensor 8 may be applied to control the position of the belt 4 and/or the print medium 15. The belt 4 is further provided with through-holes and a suction box 5 in connection with a suction source (not shown), such that negative pressure may be applied to the print medium 15 via the through-holes in the belt 4. The negative pressure sticks the print medium 15 flatly to the belt 4 and prevents displacement of the print medium 15 with respect to the belt 4. Due to this holding, the belt 4 is able to transport the print medium 15. It will be appreciated that other suitable transport means, such as rollers, steppers, etc., may alternatively be applied. The print medium 15 may be transported stepwise and/or in continuous movement.

The inkjet printing assembly 7 is configured to translate along a first guide beam 6 in a scanning direction. The scanning direction is perpendicular to the direction in which the print medium is transported by the belt 4. The inkjet printing assembly 7 holds a plurality of print heads (not shown), which are configured to jet a plurality of different marking materials (different colors of ink, primers, coatings, etc.) on the print medium 15. Each marking material for use in the printing assembly 7 is stored in one of a plurality of containers arranged in fluid connection with the respective print heads for supplying marking material to said print heads to print an image on the print medium 15.

The ejection of the marking material from the print heads is performed in accordance with data provided in the respective print job. The timing by which the droplets of marking material are released from the print heads determines their position on the print medium 15. The timing may be adjusted based on the position of the inkjet printing assembly 7 along the first guide beam 6. The above mentioned sensor 8 may therein be applied to determine the relative position and/or velocity of the inkjet printing assembly 7 with respect to the print medium 15. Based upon data from the sensor 8, the release timing of the marking material may be adjusted.

Upon ejection of the marking material, some marking material may be spilled and stay on a nozzle surface of the print heads. The marking material present on the nozzle surface may negatively influence the ejection of droplets and the placement of these droplets on the print medium 15. Therefore, it may be advantageous to remove excess marking material from the nozzle surface. The excess marking material may be removed for example by wiping with a wiper and/or by application of a suitable anti-wetting property of the surface, e.g. provided by a coating.

The marking materials may require treatment to properly fixate them on the print medium. Thereto, a fixation unit 10 is provided downstream of the inkjet printing assembly 7. The fixation unit 10 may emit heat and/or radiation to facilitate the marking material fixation process. In the example of FIG. 1, the fixation unit 10 is a radiation emitter, which emits light of certain frequencies that interacts with the marking materials, for example UV light in case of UV-curable inks. The fixation unit 10 in FIG. 1 is translatable along a second guide beam 9. Other fixation units 10, such as page-wide curing or drying stations may also be applied. Further, the inkjet printing assembly 7 may be provided with a further fixation unit on the same carriage that holds the print heads. This further fixation unit can be used to (partially) cure and/or harden the marking materials, independent of or in interaction with the fixation unit 10.

After printing, and optionally fixation, the print medium 15 is transported to a receiving unit (not shown). The receiving unit may comprise a take-up roller for winding up the print medium 15, a receiving tray for supporting sheets of print medium 15, or a rigid media handler, similar to the media input unit 14. Optionally, the receiving unit may comprise processing means for processing the medium 15 after printing, e.g. a post-treatment device such as a coater, a folder, a cutter, or a puncher.

The wide-format printer 1 furthermore comprises a user interface 11 for receiving print jobs and optionally for manipulating print jobs. The local user interface unit 11 is integrated to the print engine and may comprise a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, comprises a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Hybrid Printing System

The printer 1 in FIG. 1 is a so-called hybrid printer, capable of handling both flexible media and rigid substrates. In FIG. 1, the printer 1 operates in a first print mode, wherein the printer 1 is configured for transporting rigid substrates, such as the print medium 15. Such rigid print media 15 may be panels for doors, walls, etc., corrugated media, plates formed of plastic or metal, etc. To handle these rigid print media 15, the printer 1 in FIG. 1 is configured with a substantially linear transport path: from the media input device 14, the print medium 15 moves forward along the inkjet printing assembly 7 at a at substantially constant height. The media input unit 14 and the receiving unit are positioned at the level of the medium support surface of the belt 4. A flexible web medium (not shown) may also be supplied to the printer 1, which web medium may be composed of e.g. paper, label stock, coated paper, plastic or textile. The web medium is supplied from the input roller 2A and extends across the belt 4 to the take-up roller 2B, where the web medium is re-wound. The printer 1 is configured to swiftly and efficiently switch between print modes.

The methods of the present disclosure are also applicable to a printer which is only capable of handling rigid substrates.

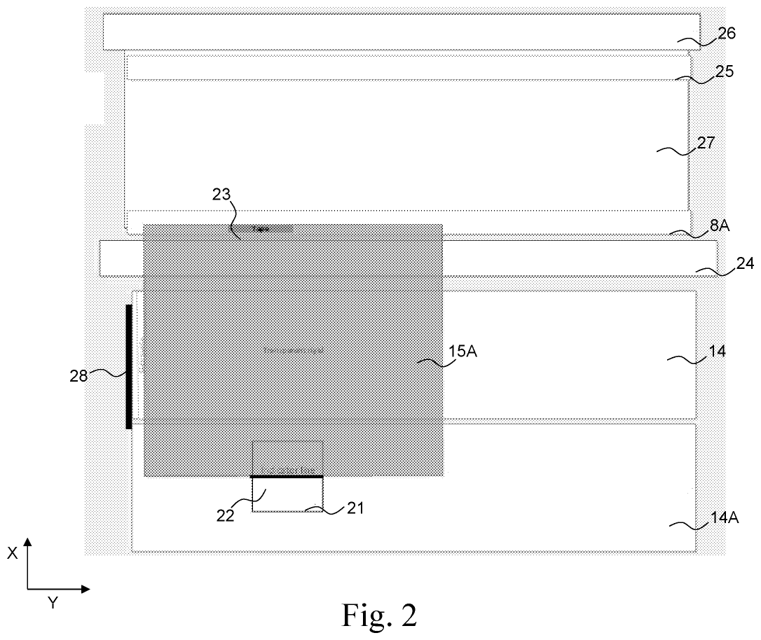

FIG. 2 is a schematic top view of the printing system with respect to the first method of calibrating the printer according to the present disclosure. A transparent print medium 15A is laid down on a feed table 14, which may be extended by an additional table 14A in case of media which have a large size in the transport direction x. The print medium 15A is provided with an adhesive element 23 at the leading edge of the print medium 15A. The adhesive element 23 can be detected by an area camera in a detection zone 8A of the area camera. The detection zone 8A is part of a print surface 27. For convenience reasons, the area camera is not shown in FIG. 2. The area camera has a reach of the detection zone 8A. The area camera generates, continuously or at regular short time intervals, a digital image of pixel having color or greytone information. The digital image is sent to the print controller, which comprises an image processing component for analyzing and processing digital images. As soon as a leading edge of the print medium 15A reaches the detection zone 8A, a simultaneously generated digital image comprises a first group of pixels representing the belt and a second group of pixels representing the print medium 15A. A difference in color or greytone between the first group of pixels and the second group of pixels is used by the image processing component in the print controller to detect a position of the leading edge of the print medium 15. The print medium 15A is fed over the feed table 14 and an idler 24 into the detection zone 8A towards the print surface 27. The print surface 27 is also provided with a traction zone 25 guiding the print medium 15A to a drive roller 26. A print head assembly (not shown) is provided above the print surface 27, which moves along with a carriage in the y direction. The print medium 15A is guided along a side guide 28 extending in the transport direction x. The side guide 28 is provided to position the print medium 15A at the correct position in the y direction. According to the method of the present disclosure, the print medium 15A is fed into the printer until the leading edge of the print medium 15A reaches the detection zone 8A of the area camera. Then the feeding is stopped, the vacuum system is invoked to suck the print medium 15A to the table 14 so that it cannot move any more. Then a sticker 21 provided with an indicator line 22 is stuck onto the table 14 or onto the additional table 14A. The position of the sticker on the table 14/14A is such that the indicator line 22 coincides with the trailing edge of the print medium 15A. The sticker 21 may consist of one-sided adhesive thin material or magnetic thin material.

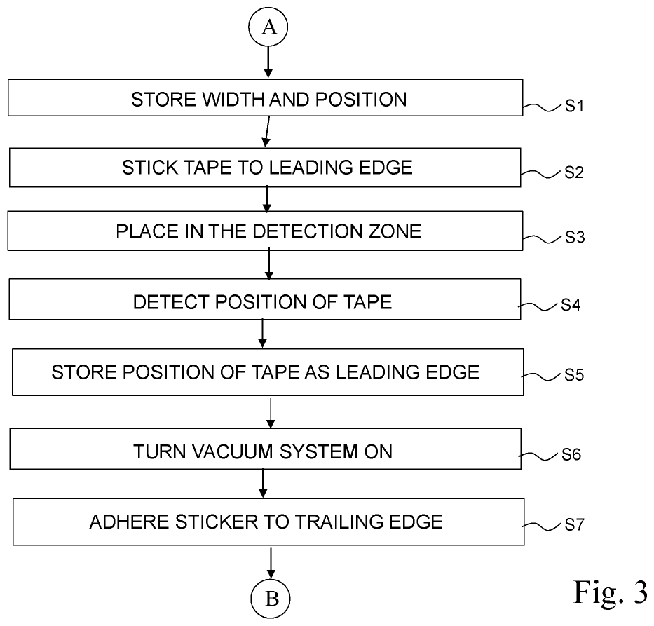

FIG. 3 is a flow diagram of the first method of calibrating the printer according to the present disclosure. The method starts at a starting point A that leads to a first step S1.

In the first step S1, a width of the transparent medium and a position of the transparent medium on the feed table is stored in memory of the print controller.

In a second step S2, an adhesive element is stuck to a leading edge of the transparent medium.

In a third step S3, the leading edge of the transparent medium is placed in a detection zone of the area camera.

In a fourth step S4, the area camera detects a position of the adhesive element.

In a fifth step S5, the position of the adhesive element is stored as being a leading edge position of the transparent medium.

In a sixth step S6, the vacuum system is turned on such that the transparent medium cannot move.

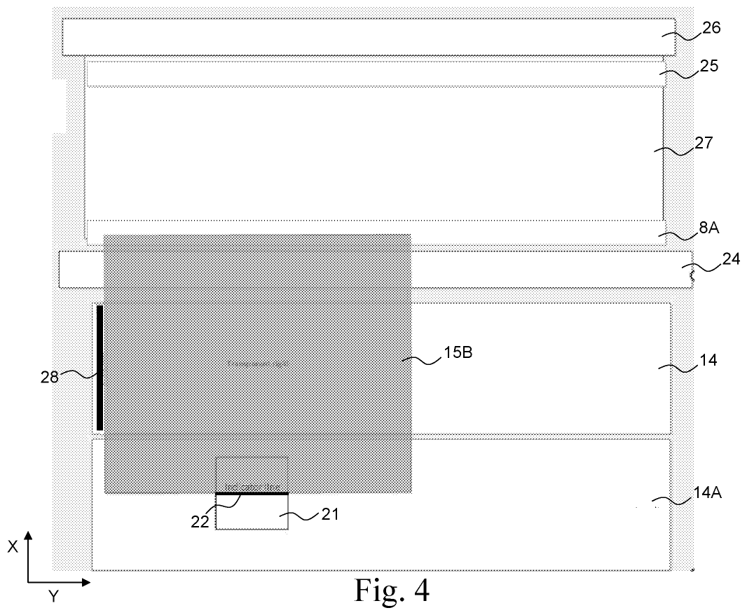

In a seventh step S7, a sheet with an indicator line, like a sticker or flat magnet, is placed and stuck on top of the feed table at the position of a trailing edge of the transparent medium. The indicator line is aligned with the trailing edge of the transparent medium. FIG. 4 is a schematic top view of the printing system with respect to the second method of printing with the printer after calibration according to the present disclosure.

A next print medium 15B of the same size in the transport direction x as the print medium 15A in FIG. 2 is fed into the printer on the table 14. The print medium 15B does not have an adhesive element at the leading edge of the print medium any more, because the adhesive element at the leading edge was only for the purpose of calibration as shown in FIG. 2 and explained in the method of FIG. 3. The print medium 15B is placed with its trailing edge on the indicator line 22 of the sticker 22. By doing so, the print medium 15B is at the correct position to start printing on the print medium 15B.

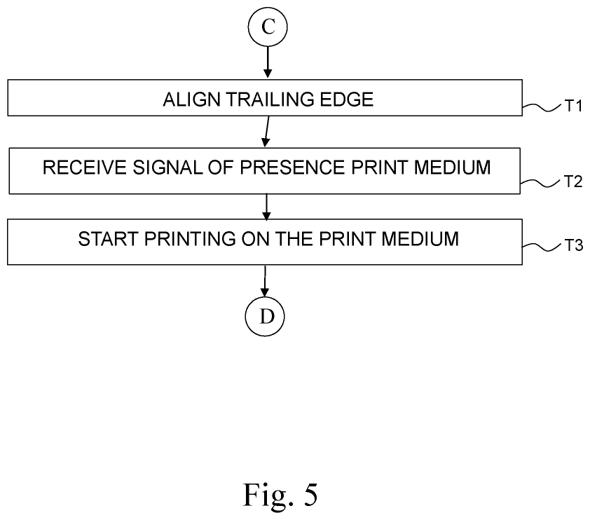

FIG. 5 is a flow diagram of the second method of printing with the printer after calibration according to the present disclosure. The method starts at a starting point C which leads to a first step T1.

In the first step T1, the trailing edge of the transparent medium is aligned with the indicator line on the sticker. This can be manually done by the operator. The area camera is ignored in the first step T1.

In a second step T2, a signal indicating a presence of the transparent medium is received by the controller of the printer. The signal may come from a user interface of the printer, for example by manual input of the operator at a screen or by using a foot pedal lying on the ground below the printer or feed table. The signal may also come from a receipt of a print job by the print controller via a network comprising workstations for print job submission.

In a third step T3, the controller starts printing on the transparent print medium. Variations in the media length of the transparent print media may be taken into account by adding larger margins in white space in the transport direction x than in case of non-transparent print media.

The method ends in an end point D.

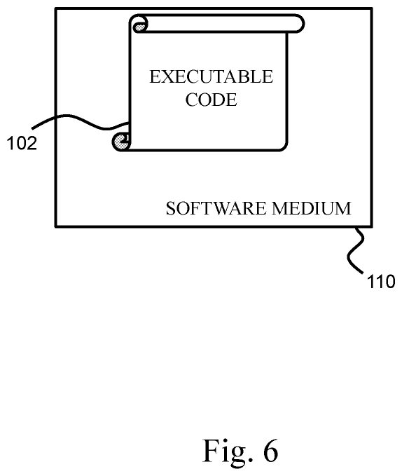

FIG. 6 schematically shows a non-transitory software/computer-readable storage medium 110 according to the disclosure. The software medium 110 comprises executable code 102 configured to, when executed, perform the method according to the disclosure, e.g. as described with respect to either the printing system 1 shown in FIG. 1 or the method of controlling the printing system 1 according to the present disclosure shown in FIGS. 2-5 and/or according to any of the variants and modifications of the printing system and/or of the method described hereinbefore.

The non-transitory software medium 110 may, specifically, be formed as a CD or a CD-ROM, a DVD or a DVD-ROM, a BluRay disc or a BluRay-ROM disc, a magnetic hard drive, a solid state disk (SSD) hard drive, a USB memory device and so on.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A method for calibration of a printer for a transparent medium, the printer comprising a user interface for user interaction, a feed table for feeding media to a print surface comprising a vacuum system to suck the media to the print surface, an area camera above the feed table for detecting the fed media, and a print controller for controlling printing on the print media, the method comprising:
storing a position of the transparent medium on the feed table in memory of the print controller;
detecting, using the area camera, a position of an adhesive element stuck to a leading edge of the transparent medium;
storing the position of the adhesive element as being a leading edge position of the transparent medium;
turning on the vacuum system to suck the transparent medium to the print surface such that the transparent medium cannot move; and
receiving a ready signal by means of the user interface that a sheet comprising an indicator line is placed on top of the feed table at the position of a trailing edge of the transparent medium.

2. The method according to claim 1, further comprising, for each transparent medium to be printed,
receiving a signal that the trailing edge of the transparent medium is aligned at the indicator line via the user interface of the printer; and
start printing on the transparent medium.

3. The method according to claim 2, wherein the signal is received from an operator using a foot pedal.

4. The method according to any of the preceding claims, wherein in placing the sheet on top of the feed table, the sheet is a magnetic sheet or a sticker sheet.

5. A method comprising: the method of calibration of the printer according to claim 1; and thereafter, printing on a print medium, if the print medium of another size is fed into the printer.

6. A printer for printing transparent media, the printer comprising:
a feed table configured to feed media to a print surface comprising a vacuum system to suck media to the print surface;
an area camera above the feed table configured to detect the fed media;
a user interface for interaction with a user of the printer and for indicating that media is fed on the feed table; and
a print controller configured to execute the steps of the method according to claim 1.

7. The printer according to claim 6, wherein the printer is a sheet printer or a hybrid printer for printing on rolls and sheets.

8. A non-transitory computer-readable storage medium storing a computer program with instructions which, when the program is executed by a print controller of a printer, cause the computer to execute the steps of the method according to claim 1.
